(19) United States
(12) Patent Application Publication
(10) Pub. No.: US 2018/0120413 A1
(43) Pub. Date: May 3, 2018

(54) RADAR SENSOR FOR MOTOR VEHICLES

(71) Applicant: Robert Bosch GmbH, Stuttgart (DE)

(72) Inventors: Andreas Stoeckle, Leonberg (DE); Klaus Baur, Mietingen (DE); Marcel Mayer, Weissach (DE)

(73) Assignee: Robert Bosch GmbH, Stuttgart (DE)

(21) Appl. No.: 15/569,914

(22) PCT Filed: Mar. 21, 2016
(86) PCT No.: PCT/EP2016/056144

§ 371 Date: Oct. 27, 2017

(30) Foreign Application Priority Data
May 13, 2015 (DE) 102015208901.0

(51) Int. Cl. G01S 7/02; G01S 13/93; H01Q 9/04; H01Q 1/32

(52) U.S. Cl. CPC G01S 7/026; H01Q 1/3233; H01Q 9/0428; G01S 13/931

(57) ABSTRACT

A radar sensor for motor vehicles, including a transmitting antenna and a receiving antenna designed separately from the transmitting antenna, wherein the transmitting antenna is configured to emit radiation circularly polarized in a first direction, and the receiving antenna is configured to receive radiation which is circularly polarized in a second direction opposite the first direction.

### FIELD

The present invention relates to a radar sensor for motor vehicles, including a transmitting antenna and a receiving antenna designed separately from the transmitting antenna.

### BACKGROUND INFORMATION

Motor vehicles are increasingly equipped with driver assistance systems which support the driver in driving the motor vehicle. Examples of such driver assistance systems are adaptive cruise control (ACC) systems, which automatically regulate the distance from a preceding vehicle, and collision warning systems or collision avoidance systems, which output a warning to the driver in the event of a collision risk or actively intervene in the vehicle guidance to avert the collision. Usually radar sensors, which typically operate at a radar frequency of 77 GHz, are used in these driver assistance systems to detect the traffic surroundings. For transmitting and receiving the radar signals, these radar sensors mostly include patch antennas which are implemented in microstrip line technology. For example, such a patch antenna may be formed by a rectangular metallized antenna element which is situated on a high frequency suitable substrate material at a defined distance from a ground plane lying underneath.

The radar sensor mostly includes multiple such antenna elements, which are situated horizontally next to one another and not only make it possible to measure the distances and relative speeds of preceding vehicles and other objects, but also have a certain angular resolution power and thus are able to determine the directional angles of the objects. In addition to radar sensors of the type considered here, in which a bistatic antenna concept is implemented, i.e., in which separate antenna elements for transmitting and for receiving are provided, radar sensors having monostatic antenna configurations are also used, in which each antenna element is used both for transmitting and for receiving the radar signals. In the radar sensors customary today, the antenna elements mostly emit linearly polarized radiation. However, radar antenna elements which transmit and receive circularly polarized radiation are also conceivable.

As the functional scope of the driver assistance systems increases, the requirements with regard to the radar sensors also rise when it comes to their ability to correctly detect ever more complex traffic situations. The radar sensors should therefore be able to measure the crucial parameters of the located objects, i.e., their distance, relative speed and angle, with high precision and accuracy, and they should preferably not be sensitive to interference signals.

One problem in this connection is the phenomenon of the so-called multiple reflection. Such multiple reflections may occur when the transmitted radar signal and/or the radar echo reflected on the object makes its way to the object and back to the radar sensor not only on a direct path, but is also reflected again once, or possibly also multiple times, on other objects in the propagation path, such as on guard rails or, possibly, also on the roadway surface. The signals resulting from such multiple reflections may simulate spurious objects, which in reality are not present at all, and they may result in imprecise or completely incorrect measurements of the object angles and the object distances, with the consequence that preceding vehicles are not assigned to the correct lane, and consequently erroneous reactions of the driver assistance system occur, for example braking or acceleration processes, which are not appropriate for the traffic situation.

### SUMMARY

It is an object of the present invention to create a radar sensor for motor vehicles with which the interfering effects of multiple reflections may be better suppressed.

According to the present invention, this object may be achieved in that the transmitting antenna is configured to emit radiation circularly polarized in a first direction, and the receiving antenna is configured to receive radiation which is circularly polarized in a second direction opposite the first direction.

The circularly polarized radiation emitted by the transmitting antenna is reflected on the located object. This reflection results in a reversal of the polarization direction, i.e., right circularly polarized radiation becomes left circularly polarized radiation, and vice versa. Due to this reversal in the polarization direction, the receiving antenna is able to receive the signal transmitted on the direct propagation path. If, in contrast, multiple reflections occur, the polarization direction again reverses with every further reflection. The repeatedly reflected first order signals, i.e., the signals which were reflected on the located object and exactly once on another object in the propagation path, then have the incorrect polarization direction so that they are received by the receiving antenna only in a highly attenuated form. The same applies for multiple reflections of a higher order having an even total number of reflections. Although repeatedly reflected signals having an odd total number of reflections, i.e., for example, triply reflected signals, are received by the receiving antenna, effective interference suppression, and thus a considerably improved accuracy and reliability, are achieved as a result of the attenuation of primarily the repeatedly reflected first order signals, since the intensity of the signals drastically decreases with the number of reflections.

In general, multiple reflections may not only be caused by objects outside the host vehicle, for example by guard rails, but also by the installation surroundings, i.e., for example, by parts of the vehicle in which the radar sensor is installed. Since such reflections are also suppressed by the radar sensor according to the present invention, a higher design freedom with respect to the installation of the radar sensor in the vehicle may be achieved.

Advantageous embodiments of the present invention are described herein.

One exemplary embodiment is described in greater detail below based on the figures.

### BRIEF DESCRIPTION OF THE DRAWINGS

FIG. 1 shows a schematic diagram of a radar sensor according to the present invention.

FIGS. 2 and 3 show layouts of traffic situations to illustrate various types of multiple reflections on objects which are part of the traffic infrastructure.

FIG. 4 shows a schematic diagram to illustrate multiple reflections which may be brought about due to a special installation of the radar sensor in a vehicle.

### BRIEF DESCRIPTION OF THE DRAWINGS

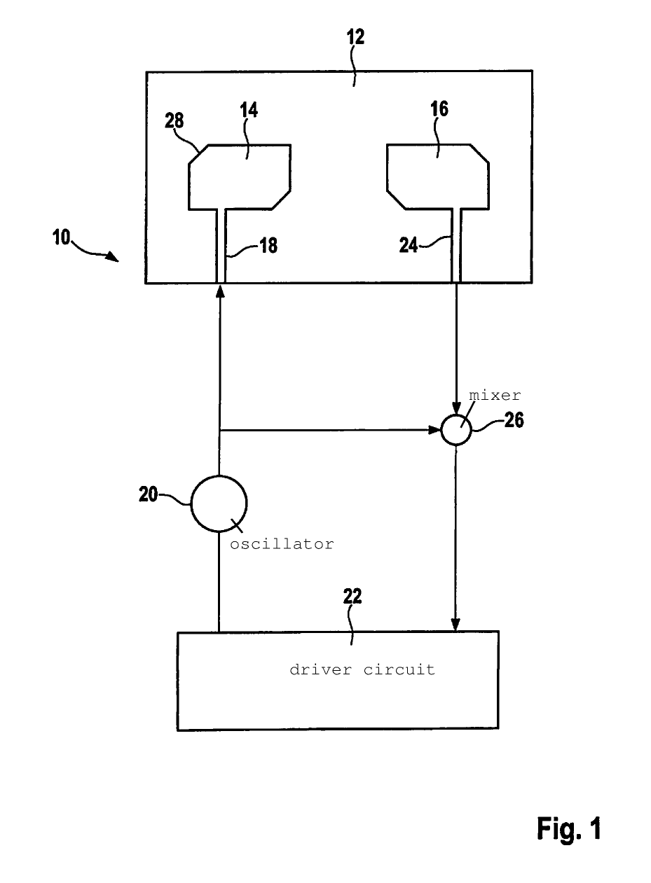

FIG. 1 shows the basic design of a radar sensor 10 according to the present invention in a drastically simplified layout. A transmitting antenna 14 and a receiving antenna 16 are formed on a surface of a circuit board 12 made of a high frequency suitable material. The antennas are designed as patch antennas and have the shape of approximately rectangular surface areas on the surface of substrate 12. A continuous ground layer is situated on the backside of the substrate which is not visible.

Transmitting antenna 14 is connected via a feed line 18 formed on the surface of the substrate, for example a microstrip line, to a local oscillator 20, which generates the radar signal to be transmitted. As an example it shall be assumed that the radar sensor operates according to the frequency modulated continuous wave radar (FMCW) principle. Oscillator 20 is then a voltage-controlled oscillator, which generates a radar signal having a ramp-like modulated frequency. The center frequency is typically 76.5 GHz. The frequency modulation is controlled by a driver circuit 22 which, among other things, supplies the control voltage for oscillator 20.

Receiving antenna 16 is connected via a dedicated feed line 24 to an input of a mixer 26. Another input of this mixer is connected to the output of oscillator 20. Mixer 26 mixes the signal received from receiving antenna 14 (radar echo) with the signal received from oscillator 20 and thus generates at its output a signal which is downmixed into a base band, whose frequency corresponds to the frequency difference between the received signal and the signal of the oscillator. This base band signal is further evaluated in driver circuit 22 in the known manner.

Due to chamfers 28 on two diagonally opposing corners and due to the feed location (connection point of feed line 18 to the antenna patch), transmitting antenna 14 is configured in such a way that, as a result of the fed signal, two oscillation modes are induced in the patch in two directions perpendicular to one another and having phases offset by 90°, so that the transmitting antenna emits circularly polarized radar radiation, i.e., depending on the emission direction either right circularly polarized radiation or left circularly polarized radiation. As an example, it shall be assumed that transmitting antenna 14 emits left circularly polarized radiation.

In practice, the emitted signal may also include a certain linearly polarized radiation portion so that, strictly speaking, the radiation is elliptically polarized. The linearly polarized radiation portion, however, may be neglected here.

In the shown example, receiving antenna 16 is designed to be mirror-inverted to transmitting antenna 14. In any case, receiving antenna 16 is configured in such a way that it preferably receives right circularly polarized radiation. Although receiving antenna 16 is also able to receive other radiation components, in particular also left circularly polarized radiation, the attenuation is considerably stronger for these radiation components, so that the reception of signal components which are not left circularly polarized is considerably suppressed.

While in the exemplary embodiment shown here the configuration of transmitting and receiving antennas 14, 16 for circularly polarized radiation is achieved by chamfers 28, such a configuration is also achievable by other means, for example by two respective feed lines, which open into two edges of the antenna patch extending perpendicularly to one another and whose lengths are matched to the wavelength of the radar signal in such a way that a phase difference of 90° results.

In the simplified example shown here, the radar sensor has only one pair of transmitting and receiving antennas. In practice, however, the radar sensor will usually include multiple such pairs, which are situated in such a way that a certain angular resolution power of the radar sensor is achieved. These may also be arranged in groups having multiple elements to enable higher focusing of the emitted power (higher antenna gain) and thereby greater ranges.

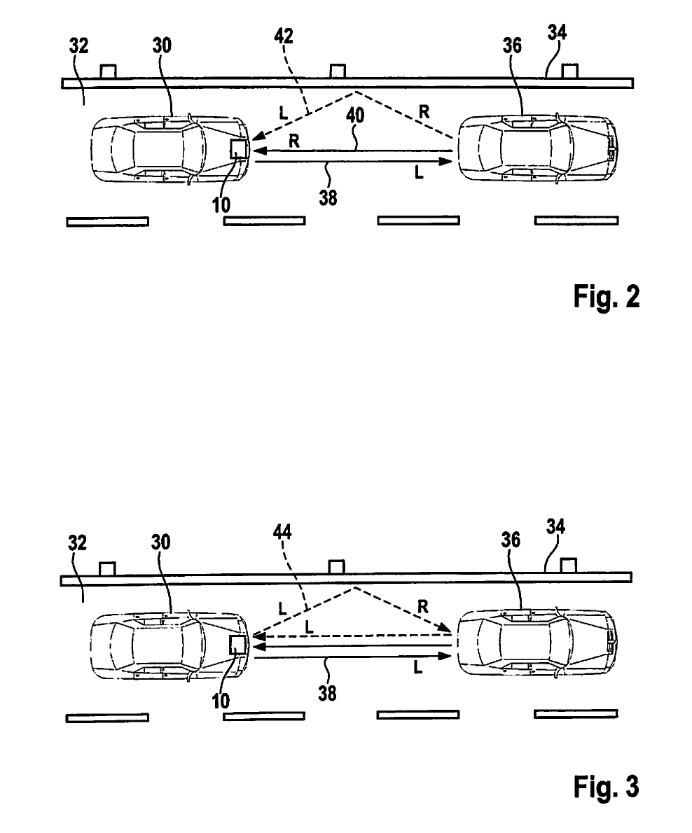

The mode of operation of the above-described radar sensor is now to be described based on FIGS. 2 through 4.

FIG. 2 shows a traffic situation in a top view in which a motor vehicle 30, which is equipped with radar sensor 10 shown in FIG. 1, drives on a roadway 32 delimited on the left side, in the driving direction, by a guard rail 34. Radar sensor 10 locates a preceding vehicle 36. As is symbolized in FIG. 2 by continuous arrows, radar sensor 10 transmits a radar signal 38, which, corresponding to the configuration of transmitting antenna 14, is left circularly polarized and is symbolized by a letter “L” on the particular arrow. The transmitted radar signal 38 impinges on the backside of preceding vehicle 36 and is reflected there. During this reflection, a reversal of the polarization direction takes place, so that a singly reflected signal 40 propagates on a direct path from the located vehicle 36 to radar sensor 10. Due to the reversal of the polarization direction, this singly reflected signal 40 is right circularly polarized, which is symbolized by a letter “R.” Since receiving antenna 16 of the radar sensor is specifically configured for the reception of right circularly polarized radiation, this directly reflected signal is received with the lowest possible attenuation and forwarded via mixer 26 to driver circuit 22.

Since the backside of preceding vehicle 36 has surface areas which are at an oblique angle to the roadway direction, or curved surface areas, a certain portion of the impinging radiation is also reflected obliquely back to guard rail 34 and impinges on the receiving antenna of radar sensor 10 again only after being again reflected on the guard rail. This signal thus forms a repeatedly reflected signal 40, more precisely a twice reflected signal, which in FIG. 2 is symbolized by a dotted arrow. Due to the reversal of the polarization direction during the first reflection on vehicle 36, this repeatedly reflected signal 40 on the path to guard rail 34 is right circularly polarized (“R”), however during the reflection on guard rail 34 the polarization direction is reversed again, so that signal 40 reaches radar sensor 10 as a left circularly polarized signal (“L”). This signal is thus received by receiving antenna 16 only in a highly attenuated form. Since, in the locating of preceding vehicle 36, the repeatedly reflected signal 42 represents an interference signal, which in particular distorts the angular measurement, an improved measuring accuracy is achieved by the suppression of this signal.

FIG. 3 illustrates another option of how multiple reflections may be created. Radar sensor 10 is configured, as is customary, in such a way that the transmitted signal 38 is bundled into a relatively narrow lobe in the forward direction of vehicle 30. This is achieved, for example, by a radar lens situated in front of the antenna elements and/or by a suitable arrangement and by suitable phase relationships between multiple transmitting antenna patches. Nevertheless the radar lobe transmitted by radar sensor 10 has a certain width in the horizontal direction transverse to the driving direction. This beam expansion is by all means desirable since it also allows vehicles traveling with angular offset to be located. Moreover, this inevitably results in the formation of side lobes directed more strongly to the side.

A portion of the radiation emitted by radar sensor 10 will therefore propagate obliquely to the side and impinge on guard rail 34 in such a way that it is reflected by the guard rail to the backside of preceding vehicle 36. After being again reflected on the backside of preceding vehicle 36, a portion of this radiation will also again impinge on receiving antenna 16 of radar sensor 10. In this way, multiple reflections may also occur in the forwardly directed propagation path from radar sensor 10 to the object, thus to preceding vehicle 36 in this case.

In FIG. 3, dotted arrows show a twice reflected signal 44, which runs from radar sensor 10 via guard rail 34 to vehicle 36 and from there back to the radar sensor. Although this repeatedly reflected signal 44 does not result in such a strong distortion of the directional angle at which vehicle 36 is located, it may still simulate a larger distance of the preceding vehicle due to the longer signal propagation time and in general “blur” the received signal pattern in such a way that a precise identification and locating of individual objects is made more difficult.

The repeatedly reflected signal 44 is left circularly polarized (“L”) on the path from the radar sensor to guard rail 34, right circularly polarized (“R”) on the path from guard rail 34 to vehicle 36, and left circularly polarized (“L”) again on the path from vehicle 36 back to radar sensor 10. As a result of receiving antenna 16 being configured for right circularly polarized radiation, this repeatedly reflected signal is also effectively suppressed.

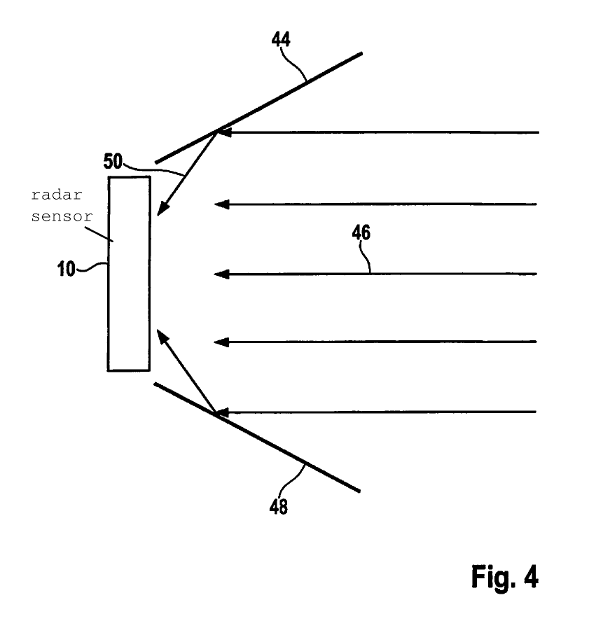

FIG. 4 schematically shows an installation situation of radar sensor 10 into motor vehicle 30, in which the installation location of the radar sensor, on the side toward which the radar radiation is emitted and from which the radar echoes are received again, is flanked by components 46, for example body parts of the motor vehicle, on which the radar radiation reflected by the objects may be reflected again. In addition to singly reflected signals 48, repeatedly reflected signals 50 thus also reach radar sensor 10 in this configuration, which may interfere with object tracking. During the renewed reflection on components 46, the polarization direction of these signals is again reversed, so that also in this case the interfering signals are received only in highly attenuated form.

1-3. (canceled)

4. A radar sensor for a motor vehicle, comprising:
a transmitting antenna and a receiving antenna designed separately from the transmitting antenna;
wherein the transmitting antenna is configured to emit radiation circularly polarized in a first direction, and the receiving antenna is configured to receive radiation circularly polarized in a second direction opposite the first direction.

5. The radar sensor as recited in claim 4, wherein the transmitting antenna and receiving antenna are patch antennas.

6. The radar sensor as recited in claim 5, wherein the configuration of the transmitting and receiving antennas for circularly polarized radiation is achieved by chamfers on corners of an otherwise rectangular antenna patch.
